(19) United States
(12) Patent Application Publication
(10) Pub. No.: US 2020/0143499 A1
(43) Pub. Date: May 7, 2020

(54) SYSTEMS AND METHODS FOR GEOGRAPHIC RESOURCE DISTRIBUTION AND ASSIGNMENT

(71) Applicant: AAA NOrthern California, Nevada & Utah, Walnut Creek, CA (US)

(72) Inventors: Murat Erdem, Orinda, CA (US); Sanjay Rashmi Shah, Fremont, CA (US)

(21) Appl. No.: 16/183,476

(22) Filed: Nov. 7, 2018

(51) Int. Cl. G06Q 50/26; G06F 17/30; G06N 5/04; G06N 99/00; G06Q 10/06

(52) U.S. Cl. CPC G06Q 50/26; G06F 17/30303; G06Q 10/06315; G06N 99/005; G06N 5/04

(57) ABSTRACT

A system including: one or more processors; and at least one memory in communication with the one or more processors and storing instructions that, when executed by the one or more processors, are configured to cause the system to: build one or more event-predictive models based on historical data; gather current data comprising at least one from among current and forecasted weather, current and planned external events, and current and expected delay factors; process the gathered current data with the built one or more event-predictive models to predict respective timeframes and locations for one or more future emergency events; identify, based on the timeframes and locations for one or more future emergency events and current and scheduled resource locations and statuses for a plurality of resources, a resource deficient area; and reposition one or more of the plurality of resources to a location corresponding to the resource deficient area.

### FIELD

The present disclosure relates generally to systems and methods for resource distribution and, more specifically, to system and method for distributing and assigning resources across a geographic area.

### BACKGROUND

The efficient allocation of resources is a consistent problem. In the related art, to respond to unscheduled, disparate events, resources are distributed in fixed locations. However, these related art approaches fail to account for varying conditions that impact event likelihoods and response times. Moreover, fixed resource locations inhibit response flexibility as geography and system interactions change over time. For example, when an accident renders a car inoperable, roadside service vehicle (e.g., tow trucks) are required. However, due to inefficient placement of roadside service vehicles, response times can be unreasonably long. This issue may be compounded in dense metro areas, where traffic patterns can greatly influence travel times.

Accordingly, there is a need for improved systems and methods for allocating resources across a geographic area. Additionally, there is a need to provide real-time adjustment of resource allocation. Certain embodiments of the present disclosure are directed to these and other considerations.

### SUMMARY

Consistent with a disclosed embodiment, there is a provided a resource allocation system including: one or more processors; and at least one memory in communication with the one or more processors and storing instructions that, when executed by the one or more processors, are configured to cause the system to: build one or more event-predictive models based on historical data, the historical data comprising at least one from among historical weather, historical external events, historical delay factors, and historical emergency events; gather current data comprising at least one from among current and forecasted weather, current and planned external events, and current and expected delay factors; process the gathered current data with the built one or more event-predictive models to predict respective timeframes and locations for one or more future emergency events; identify, based on the timeframes and locations for one or more future emergency events and current and scheduled resource locations and statuses for a plurality of resources, a resource deficient area; and reposition one or more of the plurality of resources to a location corresponding to the resource deficient area.

The instructions, when executed by the one or more processors, may be further configured to cause the system to: gather the historical data; and cleanse the historical data, the cleansing comprising at least one from among compiling the historical data, correlating portions of the historical data, removing redundancies from the historical data, and standardizing a format of the historical data.

The one or more event-predictive models may include one or more machine-learning models.

The one or more machine-learning models comprises a first machine learning model trained on older historical data of the historical data, and a second machine learning model trained on historical data substantially limited to more recent historical data of the historical data.

The instructions, when executed by the one or more processors, may be further configured to cause the system to retrain the second machine learning model iteratively as new historical data is provided.

The instructions, when executed by the one or more processors, may be further configured to cause the system to: map the one or more future emergency events and current emergency events; and overlay current and scheduled resource locations and statuses for the plurality of resources, identifying the resource deficient area being based on the map and overlay.

The instructions, when executed by the one or more processors, may be further configured to cause the system to repeatedly gather current data, process the gathered current data, identify a resource deficient area, and reposition one or more of the plurality of resources.

The instructions, when executed by the one or more processors, may be further configured to cause the system to: collect actual event data about events that actually occur; update the historical data to incorporate the actual event data; and rebuild at least one of the one or more event-predictive models based on updated historical data. Thus, the system may be configured to self-improve, adjusting its predictions over time. Moreover, in some cases, incorporating the actual event data, the models may update not only event prediction, but also response time estimates (e.g., how long it takes a resource to respond from an allocated position to an event location). Accordingly, in some cases, both event prediction and resource positioning may be improved.

According to some embodiments, there is provided a system including: one or more processors; and at least one memory in communication with the one or more processors and storing instructions that, when executed by the one or more processors, are configured to cause the system to: collect current and predicted environmental data; detect current resource, the current resource allocation indicating current location and status for a plurality of resources; analyze the current and predicted environmental data and the current resource allocation to determine improved resource allocation; and reposition one or more of the plurality of resources to a repositioned location based on the improved resource allocation.

The instructions, when executed by the one or more processors, may be further configured to cause the system to: build one or more machine-learning models based on historical environmental data; and analyze the current and predicted environmental data and the current resource allocation with the one or more machine-learning models.

The current environmental data, predicted environmental data, and historical environmental data may each include data corresponding to at least one from among weather, external events, and delay factors.

The instructions, when executed by the one or more processors, may be further configured to cause the system to retrieve at least a portion of the current and predicted environmental data from at least one from among a weather service, a transportation organization, and a social media network.

The instructions, when executed by the one or more processors, may be further configured to cause the system to analyze the current and predicted environmental data to predict timeframes and locations for at least one future emergency event. The improved resource allocation may be based on at least one from a number and type of available resources, current locations for the plurality of resources, and estimated travel times to predicted locations for the at least one future emergency event.

The instructions, when executed by the one or more processors, may be configured to cause the system to reposition the one or more of the plurality of resources based on the improved resource allocation by transmitting, to the one or more of the plurality of resources, navigation instructions to the repositioned locations.

The instructions, when executed by the one or more processors, may be configured to cause the system to reposition the one or more of the plurality of resources based on the improved resource allocation by automatically dispatching the one or more of the plurality of resources to the repositioned locations.

According to some embodiments, there is provided a resource allocation method including: building one or more event-predictive models based on historical data, the historical data comprising at least one from among historical weather, historical external events, historical delay factors, and historical emergency events; gathering current data comprising at least one from among current and forecasted weather, current and planned external events, and current and expected delay factors; processing the gathered current data with the built one or more event-predictive models to predict respective timeframes and locations for one or more future emergency events; identifying, based on the timeframes and locations for one or more future emergency events and current and scheduled resource locations and statuses for a plurality of resources, a resource deficient area; and repositioning one or more of the plurality of resources to a location corresponding to the resource deficient area.

The method may further include: mapping the one or more future emergency events and current emergency events; and overlaying current and scheduled resource locations and statuses for the plurality of resources, the identifying being based on the mapping.

The method may further include: collecting actual event data about events that actually occur; updating the historical data to incorporate the actual event data; and rebuilding at least one of the one or more event-predictive models based on updated historical data.

The repositioning the one or more of the plurality of resources may include automatically dispatching the one or more of the plurality of resources to the location corresponding to the resource deficient area.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

The accompanying drawings, which are incorporated and constitute a part of this specification, illustrate various embodiments and aspects of the disclosed embodiments and, together with the description, serve to explain the principles of the disclosed embodiments. In the drawings:

FIG. 1 illustrates an example enhanced system environment consistent with certain disclosed embodiments;

FIGS. 2 and 3 are flowcharts of example methods incorporating certain aspects of the present disclosure;

FIG. 4 is an example visual mapping according to an example embodiment; and

FIG. 5 is a computer architecture diagram that may implement certain aspects of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The disclosed embodiments are generally directed to systems and methods for resource distribution and, more specifically, to system and method for distributing and assigning resources across a geographic area. In some cases, there is provided a system that optimizes the placement and routing of roadside service vehicles. The system may utilize historic and real-time (or near real-time) environmental conditions (e.g., traffic, weather, local events, road closures, and emergencies, such as those reported to and by first responders) to schedule and position roadside resources. In some cases, machine-learning libraries may be trained from historic data for specific geographic areas. Real-time, near real-time, and/or predictive environmental data may be input to the machine-learning libraries to determine the likelihood of incidents within specific locations. Roadside service vehicles may be preemptively scheduled and/or positioned accordingly. In some embodiments, as conditions change (e.g., accidents occur or weather changes), the system may dynamically reposition roadside service vehicles in real-time.

Reference will now be made to example embodiments of the disclosed technology, examples of which are illustrated in the accompanying drawings and disclosed herein. Wherever convenient, the same references numbers will be used throughout the drawings to refer to the same or like parts.

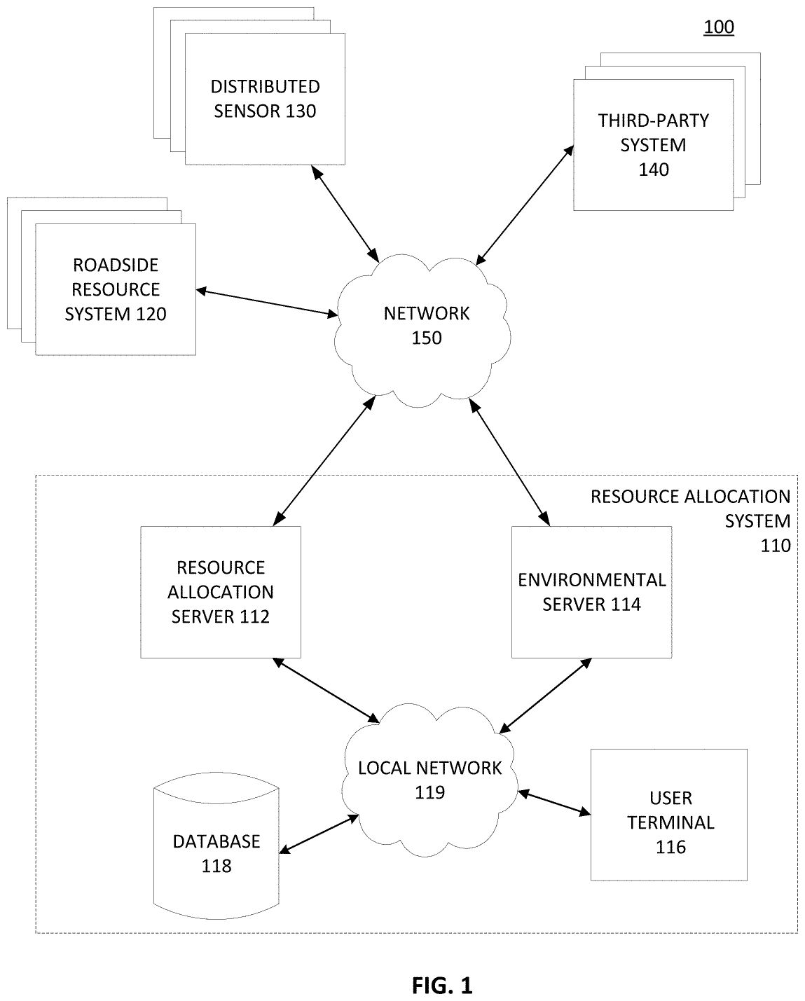

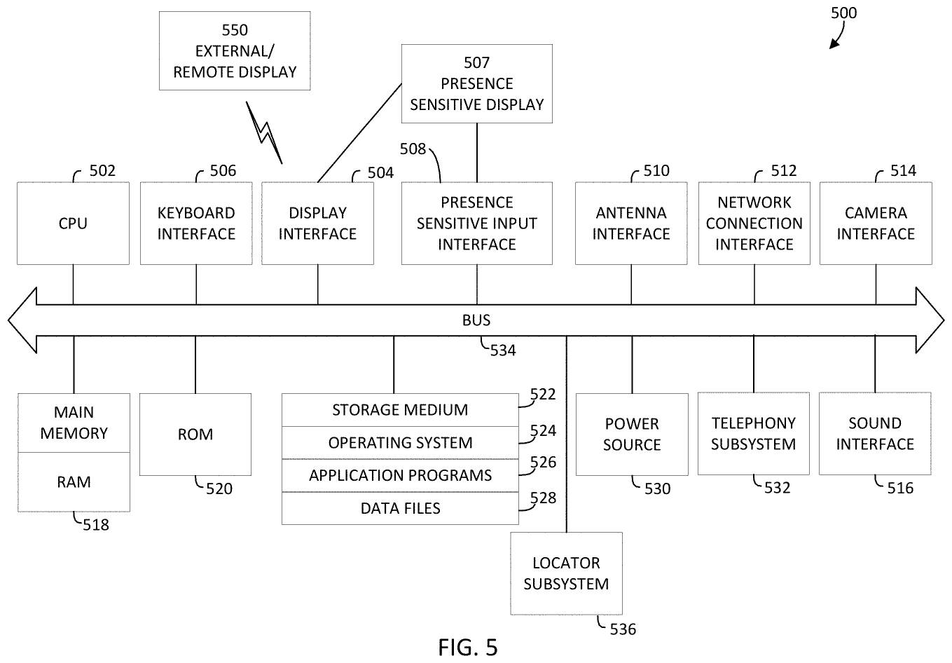

FIG. 1 illustrates an example system environment 100 consistent with the disclosed embodiments. System environment 100 may include resource allocation system 110, a plurality of roadside resource systems 120, distributed sensors 130, third-party systems 140, and a network 150. Resource allocation system may include, for example, resource allocation server 112, environmental server 114, user terminal 116, database 118, and local network 119. An example computer architecture that may be used to implement one or more aspects of system environment 100 is discussed below in greater detail with reference to FIG. 5.

Resource allocation system 110 may provide asset allocation and scheduling for the plurality of roadside resource systems 120. In some cases, resource allocation server 112 may execute one or more machine-learning libraries to estimate a current or future optimized resource allocation, and control or instruct the distribution of specific resources (e.g., resources corresponding to roadside resources systems 120). The machine-learning libraries may be trained to specific geographic locations based on historic environmental and event data. For example, environmental server 114 may gather environmental data (e.g., traffic, weather, local events, first responder data, etc.) from one or more of roadside resource systems 120, distributed sensors 130, and third-party systems 140. Resource allocation server 112 may receive the environmental data (e.g., directly from environmental server 114 or stored in database 118), and resource allocation server 112 may determine recommended resource allocation based on the environmental data (e.g., current and/or predicted). In some implementations, resource allocations server 112 may generate and/or train the machine-learning libraries (e.g., using random forest and time series models) based on historical environmental and event data stored in database 118. Such environmental and event data may be gathered in near real-time (e.g., as events occur) or after the fact (e.g., by gathering and associating historic traffic and incident data). In some cases, the historic environmental and event data may be initially gathered as a small dataset. The one or more models may be built, refined, and cross-validated for accuracy based on the small dataset. In some situations, the models may be improved by analyzing model responsiveness (e.g., changes to event prediction and response time estimates) based on changes to the smaller dataset, to tune the model. Over time, new dataset data may be added as the model is continually tuned.

In some cases, resource allocation server 112 may filter the environmental data to exclude environmental data corresponding to specific geographic areas. For example, if a specific geographic area has not hosted a threshold number of events per time period (e.g., at least 3 roadside service events in the last two years), the geographic area may not be considered for resource allocation purposes. In some instances, the geographic regions may be adjusted such that each region has hosted at least a threshold number of events per time period.

Environmental server 114 gathers environmental data (e.g., traffic, weather, local events, etc.). In some cases, environmental server 114 may request specific data from one or more of roadside resource systems 120, distributed sensors 130, and third-party systems 140. For example, environmental server 114 may request current road closures from a first third-party system 140 (e.g., a system managed by a local department of transportation), and local events schedules from a second third-party system 140 (e.g., a system managed by a local event venue). As another example, environmental server 114 may access distributed sensors 130 to determine current local traffic (e.g., based on cameras or car counters) or to detect when a local event is complete (e.g., by analyzing images of a venue and detecting large numbers of people emerging therefrom).

A system analyst may utilize user terminal 116 to control and/or modify one or more elements of resource allocation system 110. For example, a system analyst may instruct resource allocation server 112 to re-analyze environmental data (e.g., to determine if optimal resource allocation has changed), change assumptions for the resource allocation (e.g., by overriding environmental and/or event data, or modifying a number of available resources), adjust or modify environmental server 114's connection with specific environmental data sources, and/or modify the predictive models.

Database 118 may be a database associated with resource allocations system 110 that stores a variety of information relating to current and historical environmental data, impact events, response times, active resources, and/or machine learning libraries. Database 118 may also serve as a backup storage device and may contain data and information that is also stored on, for example, local databases associated with resource allocations server 112, environmental server 114, and user terminal 116. For instance, in some embodiments, database 118 may store current and historical environmental data (e.g., provided by environmental server 114 and accessed by resource allocation server 112), as well as trained predictive models.

Local network 119 may include any type of computer networking arrangement used to exchange data in a localized area, such as Wi-Fi, Bluetooth™ Ethernet, and other suitable network connections that enable components of resource allocation system 110 to interact with one another and to connect to network 150 for interacting with other components in system environment 100.

Roadside resource systems 120 may be associated with specific roadside resources. For example, roadside resource systems 120 may include one or more location sensors (e.g., GPS receivers), navigational systems, and cameras. Roadside resource systems 120 may receive instructions to move to specific locations from, for example, resource allocation server 112. In some cases, resource allocation server 112 may communicate directly with a navigational system of roadside resource system 120 to input a destination for the specific roadside resource. In some instances, the roadside resource may include one or more autonomous or partially autonomous vehicles, and the roadside resource may automatically respond to instructions from resource allocation server 112 to move the roadside resource to a specific location. Roadside resource systems 120 may further provide current information about the respective resource (e.g., location, job status) and nearby environment (e.g., camera images and transit time) to environmental server 114.

Distributed sensors 130 may include one or more sensors placed in the environment. Distributed sensors 130 may be related to resource allocation system 110 (e.g., owned or managed by a same organization). Distributed sensors 130 may provide localized environmental information to resource allocation system 110. As non-limiting examples, distributed sensors may include one or more meteorological sensors (e.g., visibility sensors, precipitation sensors, barometric sensors, and thermometers), cameras, and traffic sensors (e.g., traffic counters). In some cases, distributed sensors 130 may be incorporated with various roadside resources (e.g., attached to roadside service vehicles). In some cases, distributed sensors 130 may be incorporated within roadside resource systems 120, or may communicate through roadside resource systems 120.

Third-party systems 140 may include any external systems that collect and/or store current and/or historical environmental data. As non-limiting examples, third-party systems 140 may include one or more systems related to traffic detection (e.g., local departments of transportations), local events (e.g., venue or local even aggregators), weather (e.g., meteorological systems), local hazards (e.g., wild-fire bulletins), public holidays (e.g., calendar or governmental systems), school closures (e.g., school websites), emergency information (e.g., first responder systems), and crowd-sourced event data (e.g., social media). Resource allocation system 110 may subscribe to the third-party systems 140, or otherwise retrieve the environmental data from the third-party systems 140. In some cases, third-party systems 140 may push environmental data to environmental server 114, for example, either periodically, or in response to significant changes to the environmental data.

Network 150 may include any type of computer networking arrangement used to exchange data. For example, network 106 may be the Internet, a private data network, virtual private network using a public network, and/or other suitable connection(s) that enables components in system environment 100 to send and receive information therebetween. Network 150 may also include a public switched telephone network (“PSTN”) and/or a wireless network.

Although certain portions of system environment 100 are described as separate systems, this is merely an example, and one of ordinary skill will recognize that various components or functionality may be combined in one or more logical and/or physically separate devices.

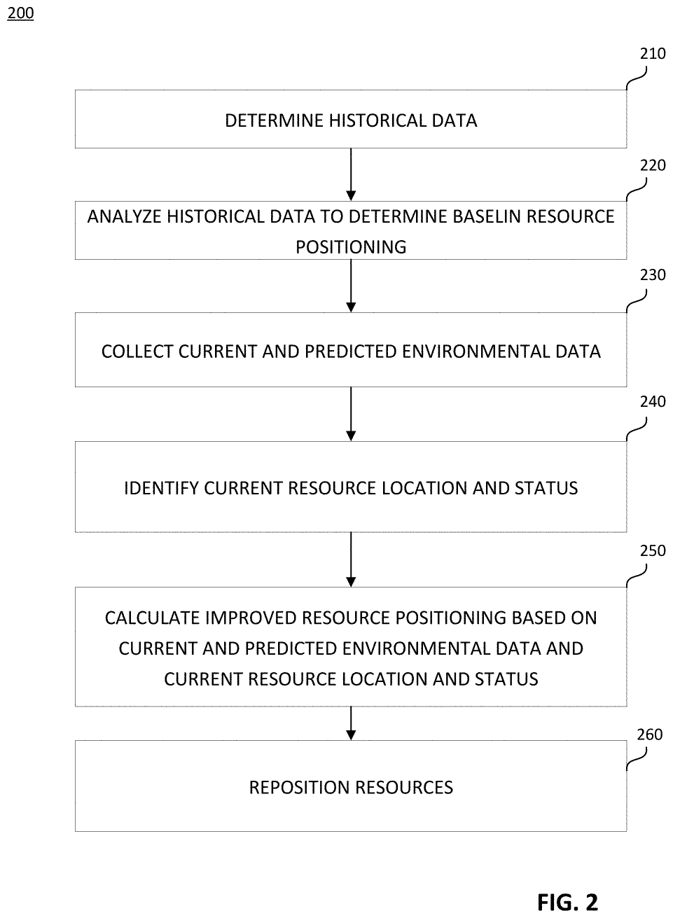

FIG. 2 is a flowchart illustrating a resource allocation method 200 according to an example embodiment. The method 200 may be performed, for example, by resource allocation system 110. Referring to FIG. 2, resource allocation system 110 determines 210 historical data (e.g., retrieves historical data from database 118 and/or environmental server 114). As non-limiting examples, the historical data may include historical weather, historical external events (e.g., sports games, concerts, holidays), historical delay factors (e.g., road closures), and corresponding emergency events (e.g., events that require roadside resources). The historical data may be collected from internal and/or external sources, and, in some cases, may be dynamically created over time.

Resource allocation system 110 analyzes 220 the historical data to determine a baseline resource positioning. For example, resource allocation server 112 may provide the historical data to one or more machine-learning predictive models, thereby training the models. Once trained, the predictive models may provide a base-resource positioning based on, for example, emergency event probabilities in specific locations and regions and/or resource availability. In some instances, a plurality of predictive models may be run simultaneously and back checked (e.g., over the past two weeks). Whichever of the predictive models is most accurate (e.g., over the past two weeks) is used as the basis for the next predictive period. In some cases, model accuracy is measured for specific circumstances (e.g., weather, time, events), and the predictive models are used as the basis for the next predictive period in certain geographic regions in a piecemeal fashion.

Resource allocation system 110 collects 230 current and predicted environmental data. For example, environmental server 114 may gather environmental data (e.g., traffic, weather, local events, etc.) from one or more of roadside resource systems 120, distributed sensors 130, and third-party systems 140. In some cases, the gathered environmental data may include predictive environmental data (e.g., weather forecasts, event end-times). In some implementations, resource allocation system 110 generates predictive environmental data. For example, resource allocation system 110 may receive raw sensor or image data from, for example, distributed sensors 130, and analyze the sensor and image data to predict future environmental data.

Resource allocation system 110 identifies 240 current resource locations and statuses. For example, resource allocation system 110 may receive location data and/or resource status data (e.g., responding to emergency event, in transit, offline, waiting) from roadside resources (e.g., roadside resource systems 120).

Based on the current and predictive environmental data and the current resource location and status, resource allocation system 110 calculates 250 improved resource positioning. For example, by processing the current and predicted environmental data with the trained machine-learning models, the models may predict times and locations for future emergency events (i.e., events that require roadside resources). Resource allocation system 110 may determine improved and/or optimized resource positioning based on the times and locations of the predicted future emergency events, as well as available resources (e.g., number of available roadside resources, type of available resource), resource status (e.g., number of service calls being currently handled), current resource location (i.e., to limit resource movement), resource requirements (e.g., current or predicted driver work hours), resource recall (e.g., time from resource location to home base), and estimated travel time (e.g., traffic conditions) to predicted future emergency event locations.

Resource allocation system 110 repositions 260 the resources to correspond to the improved positioning. In some cases, resource allocation system 110 may automatically transmit directions to the improved locations to roadside resources (e.g., roadside resource system 120). In certain implementations, resource allocation system 110 may automatically dispatch the roadside resources to the improved locations (by instructing and/or controlling autonomous vehicles).

In some cases, as emergency events occur, resource allocation system 110 may recompute improved resource positioning (e.g., when a resource becomes unavailable, the positioning of one or more remaining available resources may be adjusted to provide newly optimal (or near optimal) positioning). Similarly, in some implementations, resource allocation system 110 may monitor current and predictive environmental data for changes (e.g., changes to traffic patterns, delay in sporting events, weather changes), and recalculate improved resource positioning based thereon. In some cases, resource location “hot spots” may be predetermined for each geographic region. For example, utilizing K-means clustering on historical data, predetermined locations (e.g., 1-4) may be identified (e.g., areas with high numbers of historical events) within each geographic region for pre-positioning vehicles. Once a predicted “hot spot” is identified, resource allocation system 110 may analyze an area surrounding the hotspot (e.g., through map analysis) to identify resource positioning locations. Accordingly, in some cases, resources may be allocated between the predetermined locations for responding to resource requests within and across geographic regions.

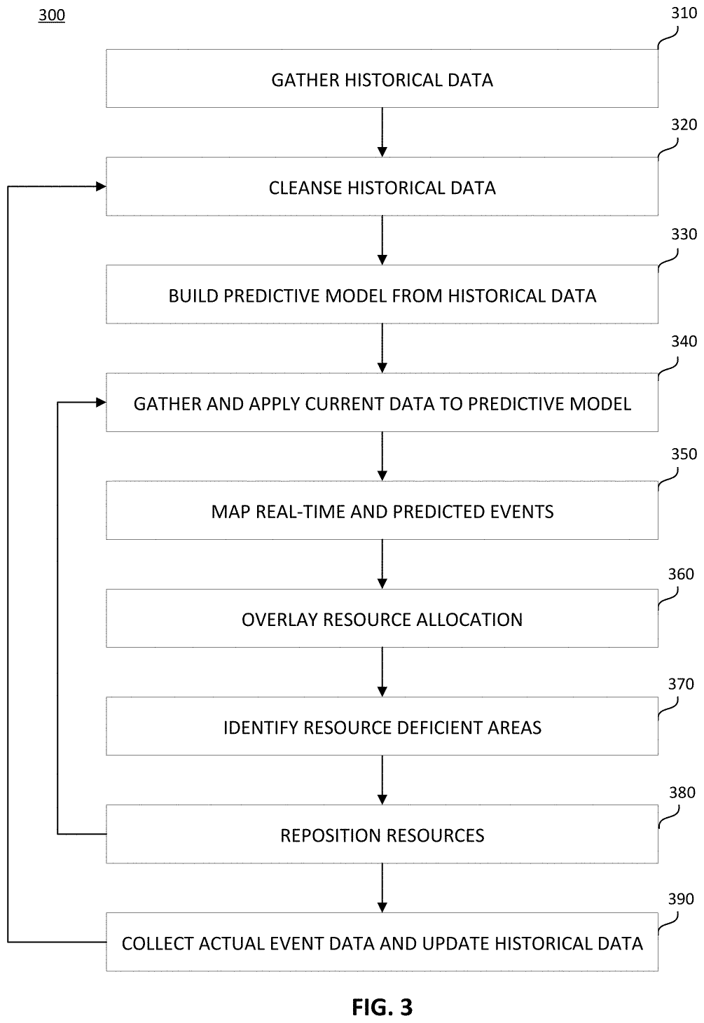

FIG. 3 is a flowchart illustrating a resource allocation method 300 according to an example embodiment. The method 300 may be performed, for example, by resource allocation system 110. Referring to FIG. 3, resource allocation system 110 gathers 310 historical environmental data (e.g., in database 118 and/or through environmental server 114). As non-limiting examples, the historical data may include historical weather, historical external events (e.g., sports games, concerts, holidays), historical delay factors (e.g., road closures), and emergency events (e.g., events that require roadside resources). The historical data may be collected from internal and/or external sources, and, in some cases, may be dynamically created over time (e.g., over three or more years).

Resource allocation system 110 cleanses 320 the historical data. For example, resource allocation system 110 may compile and correlate the historical data, remove redundancies, remove historical data linked to impossible geographic locations (e.g., with nulled longitude or latitude), and standardize formatting of the historical data. In some cases, the historical data may include both completed resource requests (e.g., calls to which a resource was actually deployed) and cancelled requests (e.g., requests for a resource that was later withdrawn). The inventors found that, surprisingly, model predictive accuracy was improved by including both completed and withdrawn resource requests. Additionally, the inventors found that increasing the resolution of weather data (e.g., from day information to hourly information) provided unexpectedly large improvements in event and response time prediction. Accordingly, in some embodiments, the use of ordinarily isolated systems may be able to provide improved trained models.

Resource allocation system 110 builds predictive models for future events. For example, resource allocation server 112 may input the historical data as a training set to one or more machine-learning predictive models, thereby training the models. The predictive model may be adaptable, such that iterative training data may be provided. In some implementations, resource allocation system 110 may utilize a plurality of machine-learning models. For example, certain models may be trained periodically (e.g., monthly), while other models may be trained iteratively with most current data. By combining the results of these varying models, event prediction may be improved. In some instances, resource allocation system 110 may utilize a plurality of machine-learning models run simultaneously and back-checked (e.g., over the past two weeks). The most accurate machine-learning model over a most recent time period (e.g., over the past two weeks) is used as the basis for the next predictive period. In some cases, resource allocation system 110 may utilize measures model accuracy as it relates to certain parameters (e.g., historic weather, time, and events), and uses different models as the basis for the next predictive period in certain geographic regions in a piecemeal fashion based on current local and global parameters. Resource allocation system 110 may select between the plurality of models, for example, when the models are updated or retrained on the updated historical data, when current conditions change (where certain models are more accurate under certain circumstances), and/or based on tracking of historical accuracy through a moving time window.

Resource allocation system 110 gathers 340 and applies current data to the predictive models. For instance, environmental server 114 may gather, as the current data, current environmental data (e.g., traffic, weather, local events, etc.) from one or more of roadside resource systems 120, distributed sensors 130, and third-party systems 140. In some cases, the gathered environmental data may include predictive environmental data (e.g., weather forecasts, event end-times). In some implementations, resource allocation system 110 generates predictive environmental data. For example, resource allocation system 110 may receive raw sensor or image data from distributed sensors 130, and analyze the sensor and image data to predict future environmental data. Current resource location and status may be received from roadside resource systems 120. Resource allocation system 110 may gather real-time emergency events (i.e., emergency events that are in process of being serviced and/or recently been serviced). The gathered information is provided to the built predictive models, which generates predicted (future) emergency events. For example, the models may predict locations, times, and emergency type for one or more emergency events based on the current data (e.g., current environmental data, real-time emergency event data, and/or current resource location and status). As non-limiting examples, emergency type may include lockout, baby in stranded vehicle, pet in stranded vehicle, tow, battery jump, battery replace, oil change, and/or tire change.

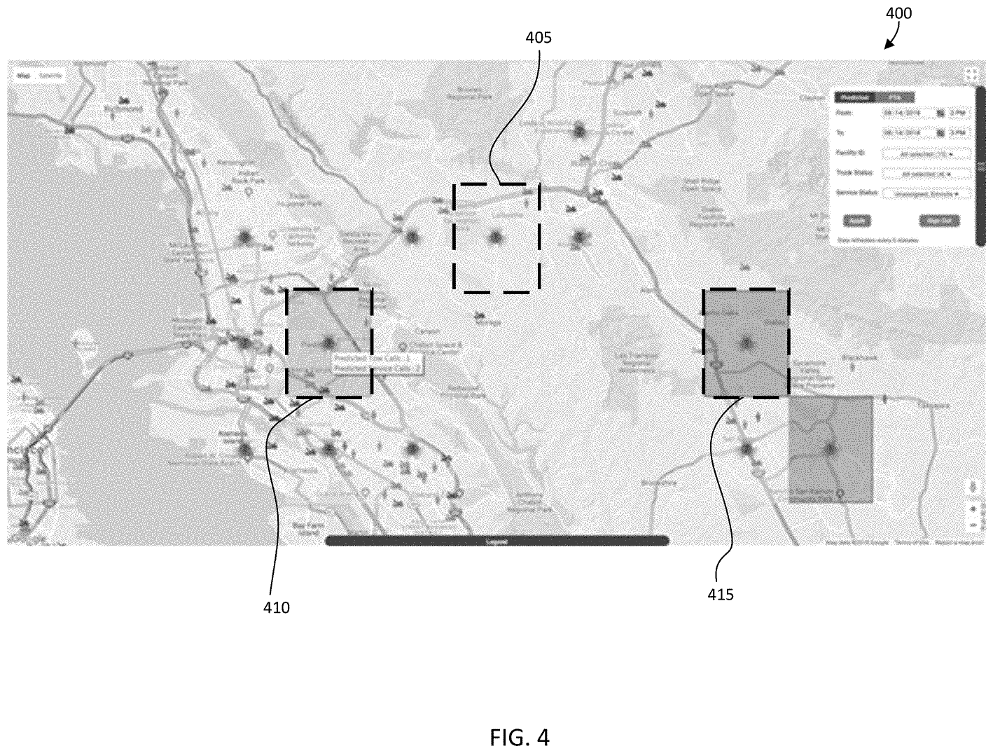

Resource allocation system 110 maps 350 real-time and predicted emergency events, and overlays 360 current and scheduled resource positioning. The mapping 350 and overlaying 360 may be visual (e.g., on a digital map) and/or logical (e.g., virtual in computer memory). The mapping 350 may be geographic (e.g., corresponding to a reasonable geographic layout), sectional (e.g., based on sectioned locations), and/or time-based (e.g., variable size 20-minute response-time borders). In some cases, border sizes and region densities (i.e., number of sections within a specific geographic area, population density, road miles and conditions within geographic area) may be variable based on, for example, number of predicted emergency events over a given time-period and changes in estimated response times. FIG. 4 illustrates visual mapping according to an example embodiment.

Resource allocation system 110 then identifies 370 resource deficient areas based on current and scheduled resource positioning and predicted emergency events. Resource allocation system 110 may determine improved and/or optimized resource positioning to address resource deficient areas. For example, based on the times and locations of predicted emergency events, as well as available resources (e.g., number of available roadside resources), current resource location (i.e., to limit resource movement), and estimated travel time (e.g., traffic conditions) to predicted future emergency event locations, resource allocation system 110 may identify improved locations for a plurality of roadside resources. In some cases, resource allocation system 110 may determine additional roadside resources are necessary (e.g., if significantly higher than expected emergency events have recently occured), and may determine positioning for resources that are to be activated.

Resource allocation system 110 repositions 380 the resources to correspond to the resource deficient areas (i.e., based on the improved or optimized resource positioning). In some cases, resource allocation system 110 may automatically transmit, to roadside resources, directions to the improved locations (e.g., roadside resource system 120 of current or to-be activated resources). In certain implementations, resource allocation system 110 may automatically dispatch the roadside resources to the improved locations (e.g., by instructing and/or controlling autonomous vehicles). Resource allocation system 110 may repeatedly gather 340 and apply newly current data (e.g., changes to environmental data, resource availability, and/or emergency event occurrence) to the predictive models, identifying 370 resource deficient areas, and again repositioning 380 the resources. Resource allocation system 110 may allocate specific resource types based on the predictive emergency types. For example, resource type may include a flatbed truck or wheel lift would be required for towing a car and a service vehicle for performing on sight repairs.

Resource allocation system 110 collects 390 actual event data (e.g., information regarding and surrounding emergency events that actually occur) and updates the historical data accordingly. The updated historical data may then be cleansed 320, and the predictive models may be rebuilt 330 and/or updated. In some cases, collecting and retraining may occur periodically (e.g., every 6 hours), or when a certain threshold of false positives and/or false negatives of predicted future emergency events over a given time period is reached.

FIG. 4 is a visual mapping 400 example according to an example embodiment. In FIG. 4 predicted events are assigned to respective regions, and regions with deficient resources are identified by color. For example, region 405 is predicted to have a single emergency event and to have sufficient resources, region 410 is predicted to have 3 emergency events and to be somewhat resource deficient, and region 415 is predicted to have a single emergency event and to be resource deficient. One of ordinary skill will recognize that the visual mapping 400 of FIG. 4 is merely an example and various changes may be made while remaining within the scope of the present disclosure. For instance, while regions 405-415 are illustrated as having substantially similar size, this is merely an example, and, in some cases, region size may vary (or be variable), such as based on number of predicted events and/or predicted travel/response times.

FIG. 5 is a block diagram of an illustrative computing device architecture 500, according to an example implementation. The computing device architecture 500 may be used to implement certain aspects of the present disclosure and/or one or more components for executing the present disclosure according to some example embodiments. For example, computer device architecture 500 may be used to implement one or more of resource allocation system 110, resource allocation server 112, environmental server 114, user terminal 116, roadside resource system 120, distributed sensor 130, and/or third-party system 140. It will be understood that the computing device architecture 500 is provided for example purposes only and does not limit the scope of the various implementations of the present disclosure. In some embodiments, various systems and/or components have fewer, alternative, or additional components as that illustrated in FIG. 5.

The computing device architecture 500 of FIG. 5 includes a central processing unit (CPU) 502, where computer instructions are processed, a display interface 504 that acts as a communication interface and provides functions for rendering video, graphics, images, and texts on the display. In certain example implementations of the disclosed technology, the display interface 504 may be directly connected to a local display, such as a touch-screen display associated with a mobile computing device. In another example implementation, the display interface 504 may be configured for providing data, images, and other information for an external/remote display 550 that is not necessarily physically connected to the mobile computing device. For example, a desktop monitor may be used for mirroring graphics and other information that is presented on a mobile computing device. In certain example implementations, the display interface 504 may wirelessly communicate, for example, via a Wi-Fi channel or other available network connection interface 512 to the external/remote display 550.

In an example implementation, the network connection interface 512 may be configured as a communication interface and may provide functions for digital virtual assistant using voice, rendering video, graphics, images, text, other information, or any combination thereof on the display. In one example, a communication interface may include a microphone, camera, serial port, a parallel port, a general-purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 504 may be operatively coupled to a local display, such as a touch-screen display associated with a mobile device or voice enabled device. In another example, the display interface 504 may be configured to provide video, graphics, images, text, other information, or any combination thereof for an external/remote display 550 that is not necessarily connected to the mobile computing device. In one example, a desktop monitor may be used for mirroring or extending graphical information that may be presented on a mobile device. In another example, the display interface 504 may wirelessly communicate, for example, via the network connection interface 512 such as a Wi-Fi transceiver to the external/remote display 550.

The computing device architecture 500 may include a keyboard interface 506 that provides a communication interface to a keyboard. In one example implementation, the computing device architecture 500 may include a presence sensitive input interface 508 for connecting to a presence sensitive display 507. According to certain example implementations of the disclosed technology, the presence sensitive input interface 508 may provide a communication interface to various devices such as a pointing device, a touch screen, a depth camera, microphone, etc. which may or may not be associated with a display.

The computing device architecture 500 may be configured to use an input device via one or more of input/output interfaces (for example, the keyboard interface 506, the display interface 504, the presence sensitive input interface 508, network connection interface 512, camera interface 514, sound interface 516, etc.) to allow a user to capture information into the computing device architecture 500. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 500 or may be a separate device. For example, the input device may be an accelerometer, a magnetometer, a digital camera, a microphone, and an optical sensor.

Example implementations of the computing device architecture 500 may include an antenna interface 510 that provides a communication interface to an antenna; a network connection interface 512 that provides a communication interface to a network. As mentioned above, the display interface 504 may be in communication with the network connection interface 512, for example, to provide information for display on a remote display that is not directly connected or attached to the system. In certain implementations, camera interface 514 acts as a communication interface and provides functions for capturing digital images from a camera. In certain implementations, a sound interface 516 is provided as a communication interface for converting sound into electrical signals using a microphone and for converting electrical signals into sound using a speaker. According to example implementations, a random-access memory (RAM) 518 is provided, where computer instructions and data may be stored in a volatile memory device for processing by the CPU 502.

According to an example implementation, the computing device architecture 500 includes a read-only memory (ROM) 520 where invariant low-level system code or data for basic system functions such as basic input and output (I/O), startup, or reception of keystrokes from a keyboard are stored in a non-volatile memory device. According to an example implementation, the computing device architecture 500 includes a storage medium 522 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including, for example, a web browser application, a widget or gadget engine, and or other applications, as necessary) and data files 528 are stored. According to an example implementation, the computing device architecture 500 includes a power source 530 that provides an appropriate alternating current (AC) or direct current (DC) to power components.

According to an example implementation, the computing device architecture 500 includes a telephony subsystem 532 that allows the computing device to transmit and receive sound over a telephone network. In some cases, the computing device architecture 500 includes a locator subsystem 536 (e.g., GPS) that allows the computing device to determine a location of the computing device. The constituent devices and the CPU 502 communicate with each other over a bus 534.

According to an example implementation, the CPU 502 has appropriate structure to be a computer processor. In one arrangement, the CPU 502 may include more than one processing unit. The RAM 518 interfaces with the computer BUS 534 to provide quick RAM storage to the CPU 502 during the execution of software programs such as the operating system application programs, and device drivers. More specifically, the CPU 502 loads computer-executable process steps from the storage medium 522 or other media into a field of the RAM 518 to execute software programs. Data may be stored in the RAM 518, where the data may be accessed by the computer CPU 502 during execution.

The storage medium 522 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 522, which may include a machine-readable storage medium.

According to one example implementation, the term computing device, as used herein, may be a CPU, or conceptualized as a CPU (for example, the CPU 502 of FIG. 5). In this example implementation, the computing device (CPU) may be coupled, connected, and/or in communication with one or more peripheral devices, such as display. In another example implementation, the term computing device, as used herein, may refer to a mobile computing device such as a smart phone, tablet computer, or smart watch. In this example implementation, the computing device may output content to its local display and/or speaker(s). In another example implementation, the computing device may output content to an external display device (e.g., over Wi-Fi) such as a TV or an external computing system.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A resource allocation system comprising:
one or more processors; and
at least one memory in communication with the one or more processors and storing instructions that, when executed by the one or more processors, are configured to cause the system to:
build one or more event-predictive models based on historical data, the historical data comprising at least one from among historical weather, historical external events, historical delay factors, and historical emergency events;
receive current data comprising at least one from among current and forecasted weather, current and planned external events, and current and expected delay factors;
process the received current data with the built one or more event-predictive models to predict respective timeframes and locations for one or more future emergency events;
identify, based on the timeframes and locations for one or more future emergency events and current and scheduled resource locations and statuses for a plurality of resources, a resource deficient area; and
reposition one or more of the plurality of resources to a location corresponding to the resource deficient area.

2. The system of claim 1, wherein the instructions, when executed by the one or more processors, are further configured to cause the system to:
receive the historical data; and
cleanse the historical data, the cleansing comprising at least one from among compiling the historical data, correlating portions of the historical data, removing redundancies from the historical data, and standardizing a format of the historical data.

3. The system of claim 1, wherein the one or more event-predictive models comprises one or more machine-learning models.

4. The system of claim 3, wherein the one or more machine-learning models comprises a first machine learning model trained on older historical data of the historical data, and a second machine learning model trained on historical data substantially limited to more recent historical data of the historical data.

5. The system of claim 4, wherein the instructions, when executed by the one or more processors, are further configured to cause the system to retrain the second machine learning model iteratively as new historical data is provided.

6. The system of claim 1, wherein the instructions, when executed by the one or more processors, are further configured to cause the system to:
receive, from an external meteorological sensor, raw sensor data; and
predict the respective timeframes and locations for the one or more future emergency events based on the raw sensor data.

7. The system of claim 1, wherein the instructions, when executed by the one or more processors, are further configured to cause the system to:
map the one or more future emergency events and current emergency events; and
overlay current and scheduled resource locations and statuses for the plurality of resources, identifying the resource deficient area being based on the map and overlay

8. The system of claim 1, wherein the instructions, when executed by the one or more processors, are further configured to cause the system to:
repeatedly gather current data, process the gathered current data, identify a resource deficient area, and reposition one or more of the plurality of resources.

9. The system of claim 1, wherein the instructions, when executed by the one or more processors, are further configured to cause the system to:
receive actual event data about events that actually occur;
update the historical data to incorporate the actual event data; and
rebuild at least one of the one or more event-predictive models based on updated historical data.

10. A resource allocation system comprising:
one or more processors; and
at least one memory in communication with the one or more processors and storing instructions that, when executed by the one or more processors, are configured to cause the system to:
receive current and predicted environmental data;
detect current resource, the current resource allocation indicating current location and status for a plurality of resources;
analyze the current and predicted environmental data and the current resource allocation to determine improved resource allocation; and
reposition one or more of the plurality of resources to a repositioned location based on the improved resource allocation.

11. The system of claim 10, wherein the instructions, when executed by the one or more processors, are further configured to cause the system to:
build one or more machine-learning models based on historical environmental data; and
analyze the current and predicted environmental data and the current resource allocation with the one or more machine-learning models.

12. The system of claim 11, wherein the current environmental data, predicted environmental data, and historical environmental data each comprise data corresponding to at least one from among weather, external events, and delay factors.

13. The system of claim 10, wherein the instructions, when executed by the one or more processors, are further configured to cause the system to retrieve at least a portion of the current and predicted environmental data from at least one from among a weather service, and a transportation organization.

14. The system of claim 10, wherein
the instructions, when executed by the one or more processors, are further configured to cause the system to analyze the current and predicted environmental data to predict timeframes and locations for at least one future emergency event, and
the improved resource allocation is based on at least one from a number and type of available resources, current locations for the plurality of resources, and estimated travel times to predicted locations for the at least one future emergency event.

15. The system of claim 10, wherein the instructions, when executed by the one or more processors, are configured to cause the system to reposition the one or more of the plurality of resources based on the improved resource allocation by transmitting, to the one or more of the plurality of resources, navigation instructions to the repositioned locations.

16. The system of claim 10, wherein the instructions, when executed by the one or more processors, are configured to cause the system to reposition the one or more of the plurality of resources based on the improved resource allocation by automatically dispatching the one or more of the plurality of resources to the repositioned locations.

17. A resource allocation method comprising:
building one or more event-predictive models based on historical data, the historical data comprising at least one from among historical weather, historical external events, historical delay factors, and historical emergency events;
gathering current data comprising at least one from among current and forecasted weather, current and planned external events, and current and expected delay factors;
processing the gathered current data with the built one or more event-predictive models to predict respective timeframes and locations for one or more future emergency events;
identifying, based on the timeframes and locations for one or more future emergency events and current and scheduled resource locations and statuses for a plurality of resources, a resource deficient area; and
repositioning one or more of the plurality of resources to a location corresponding to the resource deficient area.

18. The method of claim 17, further comprising:
mapping the one or more future emergency events and current emergency events; and
overlaying current and scheduled resource locations and statuses for the plurality of resources, the identifying being based on the mapping.

19. The method of claim 17 further comprising:
receiving actual event data about events that actually occur;
updating the historical data to incorporate the actual event data; and
rebuilding at least one of the one or more event-predictive models based on updated historical data.

20. The method of claim 17, wherein the repositioning the one or more of the plurality of resources comprises automatically dispatching the one or more of the plurality of resources to the location corresponding to the resource deficient area.
